(19) United States
(12) Patent Application Publication
(10) Pub. No.: US 2025/0271690 A1
(43) Pub. Date: Aug. 28, 2025

(54) SIDE COVER FIXED SPECTACLE FRAME STRUCTURE

(71) Applicant: PROHERO GROUP CO., LTD., TAINAN CITY (TW)

(72) Inventor: PEN-WEI CHEN, TAINAN CITY (TW)

(21) Appl. No.: 18/587,024

(22) Filed: Feb. 26, 2024

(51) Int. Cl. G02C 11/00

(52) U.S. Cl. CPC G02C 11/12; G02C 2200/04

(57) ABSTRACT

The present invention relates to a side cover fixed spectacle frame structure. The spectacle frame has two pivot seats arranged on both sides thereof. The pivot seat has an upper embedding groove and a lower embedding groove correspondingly recessed at an upper end and a lower end thereof, and a positioning hole provided on a side wall of the lower embedding groove. Each of the side covers has an assembly base correspondingly provided at one of the pivot seats, and a shielding piece extending and protruding from a lower end of the assembly base for shielding. The assembly base has a receiving groove formed on an inner side thereof, an upper embedding portion and a lower embedding portion protruding formed on an upper end and a lower end of the receiving groove, and a positioning protrusion arranged the lower embedding portion. Therefore, the side covers can be easily replaced freely.

### BACKGROUND OF THE PRESENT INVENTION

### Field of Invention

The present invention relates to a side cover fixed spectacle frame structure, in particular to a structure that is simpler and more convenient to assemble and will not fall off after assembly. It not only prevents strong wind and foreign objects from contacting the eyes to achieve the effect of protecting the eyes but also has aesthetic visual effects and enhances product competitiveness. Furthermore, it innovatively designs the side cover fixed spectacle frame structure with increased practical and functional characteristics in its overall implementation and use.

### Description of Related Arts

Common types of glasses can be roughly divided into optical glasses, sunglasses, sports glasses, night vision protective glasses, etc. in terms of function for users to choose and wear according to different times and different needs, so that most existing consumers usually have multiple pairs of glasses with different functions for easy replacement.

Among them, people are generally accustomed to wearing various types of goggles in order to protect their eyes from being hit by strong winds or being injured by collisions with foreign objects when engaging in certain jobs or performing high-speed activities. The covering portions of this type of goggles formed on both sides of the frame cover and fit around the user's eyes to prevent strong wind and foreign objects from contacting the eyes, thus achieving the effect of protecting the eyes.

However, although the above-mentioned goggles can provide users with the expected effect of protecting their eyes from strong winds and foreign object contact when worn, it has also been found in its actual operation and use that the covering portions provided on both sides of the frame of these types of goggles are directly extended and integrally formed on both sides of the frame, resulting in an extremely monotonous overall shape and color. Users cannot choose and match according to their preferences, which leads to the inability to effectively enhance the competitiveness of the product and still leaves room for improvement in the overall structural design.

In view of this, the inventor has relied on many years of rich design, development and actual production experience in this related industry, researched and improved the conventional structure and deficiencies, and provided a side cover fixed spectacle frame structure in order to achieve better practical value.

### SUMMARY OF THE PRESENT INVENTION

The main purpose of the present invention is to provide a side cover fixed spectacle frame structure that mainly allows users to choose different shapes and colors of side covers according to their own preferences and needs and then assemble and fix the selected side covers on both sides of the spectacle frame, making assembly easier and more convenient and ensuring that the side covers will not fall off after assembly, so that when the user wears the spectacle, the side covers can be used to cover and fit around the user's eyes to prevent strong wind and foreign objects from contacting the eyes, thereby protecting the eyes and providing a more beautiful visual effect, increasing the competitiveness of its products, and thereby increasing its practical and functional properties in its overall implementation and use.

The main purpose and effect of the side cover fixed spectacle frame structure of the present invention are achieved by the following specific technical means,
which mainly include a spectacle frame and two side covers, wherein
the spectacle frame has two corresponding pivot seats arranged on both sides thereof, and the two temples pivoted to each other with the pivot seats, wherein each of the pivot seats has an upper embedding groove and a lower embedding groove correspondingly recessed at an upper end and a lower end thereof, and a positioning hole provided on a side wall of the lower embedding groove, wherein
each of the side covers has an assembly base correspondingly provided at one of the pivot seats of the spectacle frame, and a shielding piece extending and protruding from a lower end of the assembly base for shielding, wherein the assembly base has a receiving groove formed on an inner side thereof for the pivot seat to be received, an upper embedding portion and a lower embedding portion protruding formed on an upper end and a lower end of the receiving groove of the assembly base, and a positioning protrusion that is capable of being embedded and positioned protruding from the lower embedding portion corresponding to the positioning hole opened in the side wall of the lower embedding groove, wherein the upper embedding portion is embedded in the upper embedding groove, and the lower embedding portion is embedded in the lower embedding groove.

In a preferred embodiment of the side cover fixed spectacle frame structure of the present invention, the shielding piece also extends and protrudes from an upper end of the assembly base for shielding.

### BRIEF DESCRIPTION OF THE DRAWINGS

FIG. 1 is an exploded view according to the present invention.

FIG. 2 is a rear exploded sectional view according to the present invention.

FIG. 3 is an assembled perspective view according to the present invention.

FIG. 4 is an assembled perspective view according to another angle of the present invention.

FIG. 5 is a rear assembled sectional view according to the present invention.

### DETAILED DESCRIPTION OF THE PREFERRED EMBODIMENT

In order to have a more complete and clear disclosure of the technical content, the purpose of invention and the effect achieved by the present invention, it is explained in detail below, and refer to the disclosed drawings and drawing numbers together.

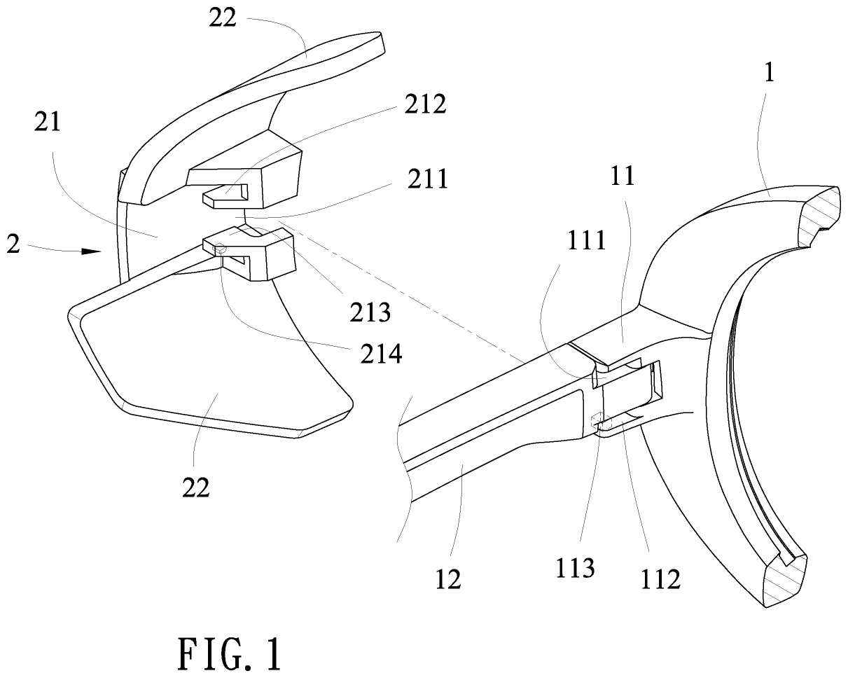

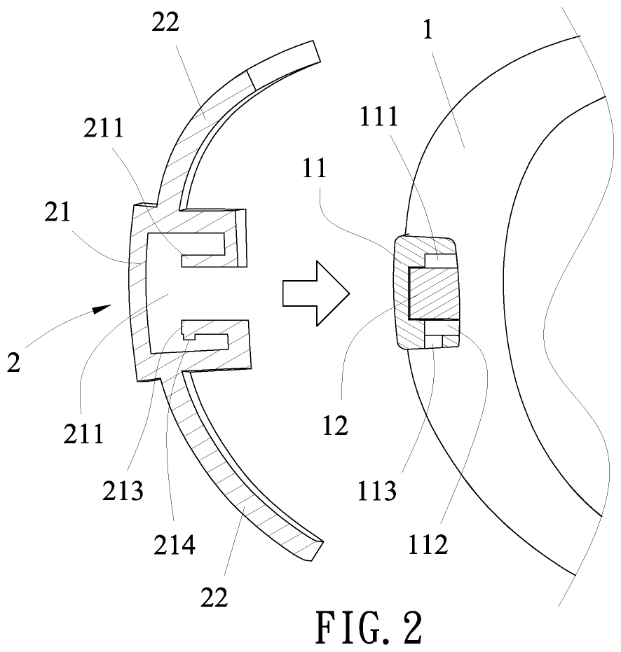

First, referring to FIG. 1, which is an exploded perspective view of the present invention, and FIG. 2, which is a rear exploded sectional view of the present invention, the present invention mainly includes a spectacle frame (1) and two side covers (2), wherein
the spectacle frame (1) has two corresponding pivot seats (11) arranged on both sides thereof, and the two temples (12) that are pivoted to each other with the pivot seats (11), wherein each of the pivot seats (11) has an upper embedding groove (111) and a lower embedding groove (112) correspondingly recessed at an upper end and a lower end thereof, and a positioning hole (113) provided on a side wall of the lower embedding groove (112), wherein
each of the side covers (2) has an assembly base (21) correspondingly provided at one of the pivot seats (11) of the spectacle frame (1), and a shielding piece (22) extending and protruding from an upper end and a lower end of the assembly base (21) for shielding, wherein the assembly base (21) has a receiving groove (211) formed on an inner side thereof for the pivot seat (11) to be received, an upper embedding portion (212) and a lower embedding portion (213) protruding formed on an upper end and a lower end of the receiving groove (211) of the assembly base (21), and a positioning protrusion (214) that is capable of being embedded and positioned protruding from the lower embedding portion (213) corresponding to the positioning hole (113) opened in the side wall of the lower embedding groove (112), wherein the upper embedding portion (212) is capable of being embedded in the upper embedding groove (111), and the lower embedding portion (213) is capable of being embedded in the lower embedding groove (112).

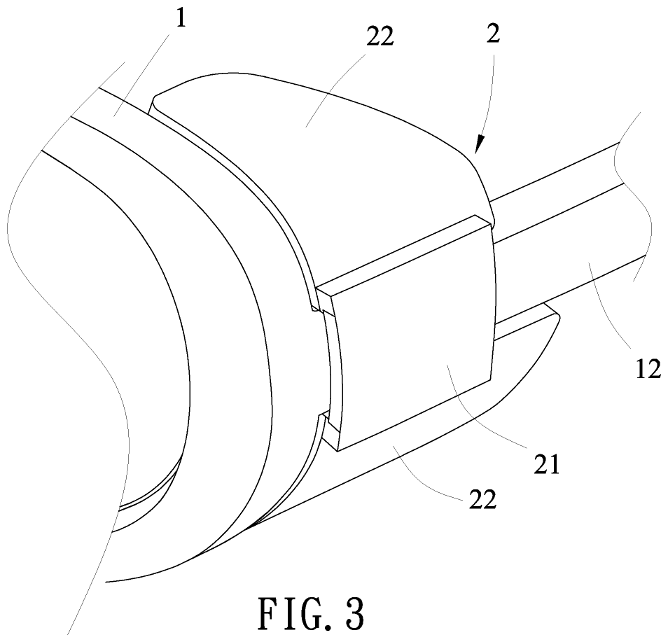

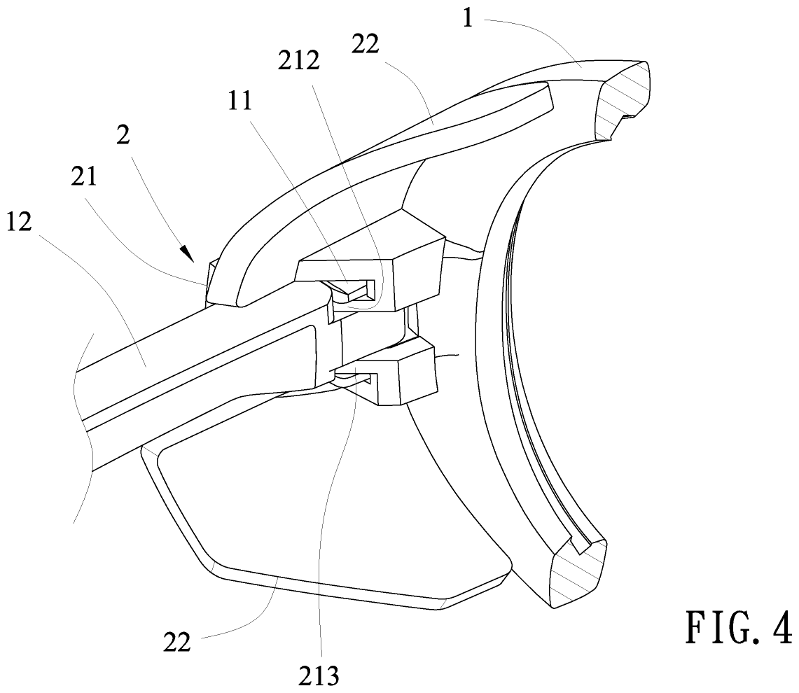

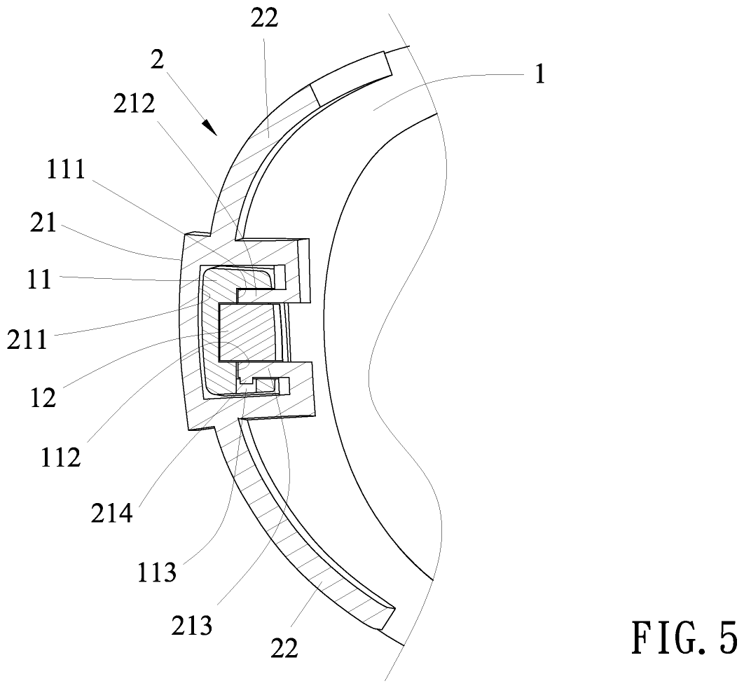

In this way, refer to FIG. 3, which is an assembled perspective view of the present invention, FIG. 4, which is an assembled perspective view of the present invention from another angle, and FIG. 5, which is a rear assembled sectional view of the present invention, so that the side cover fixed spectacle frame structure of the present invention allows the user to select the style of the side covers (2) that is desired to be matched with the spectacle frame (1) according to the user's preferences and needs. When the temples (12) pivoted on the pivot seats (11) on both sides of the spectacle frame (1) are folded, the side cover (2) is assembled corresponding to each of the pivot seats (11) of the spectacle frame (1) through the assembly base (21), so that the assembly base (21) is sleeved and combined with the pivot seat (11) using the receiving groove (211). At this time, the upper embedding portion (212) of the assembly base (21) can be fitted into the upper embedding groove (111) of the pivot seat (11), the lower embedding portion (213) of the assembly base (21) can be fitted into the lower embedding groove (112) of the pivot seat (11), and the positioning protrusion (214) on the lower embedding portion (213) is engaged and positioned with the positioning hole (113) opened in the side wall of the lower embedding groove (112), so that the pivot seat (11) is indeed accommodated and positioned in the receiving groove (211) without falling off. The temples (12) can then be unfolded, so that when the user wears spectacles, the side cover (2) is used to cover and fit the user's eyes around by using the shielding piece (22) extending from the upper and lower ends of the assembly base (21) to prevent strong wind and foreign bodies from coming into contact with the eyes, thereby achieving the effect of protecting the eyes. In addition, when the side covers (2) are to be replaced or disassembled, the two temples (12) are also folded, and then the side covers (2) can be removed from the corresponding pivot seats (11).

With the above description, the implementation of the present invention can be understood. Compared with the conventional technical means, the invention mainly allows users to choose different shapes and color patterns of side covers according to their preferences and needs. Then assemble and fix the selected side covers on both sides of the spectacle frame. The assembly process is easier and more convenient, and the side covers will not fall off after assembly and combination. When the user wears the spectacles, the side covers can be used to cover and fit around the user's eyes, which not only prevents strong wind and foreign objects from touching the eyes and achieves eye protection but also has aesthetic visual effects and increases product competitiveness. Moreover, it also enhances practicality and effectiveness in overall use.

What is claimed is:

1. A side cover fixed spectacle frame structure, which mainly comprises a spectacle frame and two side cover, wherein
the spectacle frame has two corresponding pivot seats arranged on both sides thereof, and the two temples pivoted to each other with the pivot seats, wherein each of the pivot seats has an upper embedding groove and a lower embedding groove correspondingly recessed at an upper end and a lower end thereof, and a positioning hole provided on a side wall of the lower embedding groove, wherein
each of the side covers has an assembly base correspondingly provided at one of the pivot seats of the spectacle frame, and a shielding piece extending and protruding from a lower end of the assembly base for shielding, wherein the assembly base has a receiving groove formed on an inner side thereof for the pivot seat to be received, an upper embedding portion and a lower embedding portion protruding formed on an upper end and a lower end of the receiving groove of the assembly base, and a positioning protrusion that is capable of being embedded and positioned protruding from the lower embedding portion corresponding to the positioning hole opened in the side wall of the lower embedding groove, wherein the upper embedding portion is embedded in the upper embedding groove, and the lower embedding portion is embedded in the lower embedding groove.

2. The side cover fixed spectacle frame structure as claimed in claim 1, wherein the shielding piece also extends and protrudes from an upper end of the assembly base for shielding.
